(19) United States
(12) Patent Application Publication
(10) Pub. No.: US 2006/0236320 A1
(43) Pub. Date: Oct. 19, 2006

(54) Computer platform system image automatic loading method and system

(75) Inventors: Jia-Chuan Chen, Taipei (TW); Wey-Soun Ho, Taipei (TW); Elliot Chiang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/048,092

(22) Filed: Jan. 31, 2005

(51) Int. Cl. G06F 9/445

(52) U.S. Cl. 717/176

(57) ABSTRACT

A computer platform system image automatic loading method and system is proposed, which is designed for use in conjunction with a server on a computer production line for providing a system image automatic loading procedure for a number of computer platforms on the computer production line, and which is characterized by the use of network technology to remotely detect the model of each linked computer platform, and then download a model-compliant system image in a multicast manner to all of the linked computer platforms. This feature allows the loading of system image into computer platforms without having to remove hard disk modules therefrom and without the need to manually select a model-compliant system image, and therefore allows the computer production to be more efficient and reliable than prior art.

### BACKGROUND OF THE INVENTION

1. Field of the Invention

This invention relates to computer technology, and more particularly, to a computer platform system image automatic loading method and system which is designed for use with a server in a computer production line for providing a system image automatic loading procedure that is capable of automatically loading a system image into each computer platform being manufactured on the production line, such as desktop computer, notebook computer, tablet computer, pocket computer, network server, and so on, for the purpose of allowing each manufactured computer platform to be preloaded with operating system and application programs before being shipped to the market or customers.

2. Description of Related Art

Personal computer (PC) products, such as desktop computers, notebook computers, tablet computers, pocket computers, and the like, are typically preloaded in factory with operating systems and application/utility programs as well as related product information, so that customers can immediately use the computers after purchase without having to install operating system and application programs by themselves.

In practical implementation, it is required to create a system image which is a clustered collection of all the operating system and application/utility programs as well as related system configuration settings on a PC, so that all of the operating system and application/utility programs as well as related system configuration settings can be loaded into a PC product in just one pass by simply loading the system image without having to install them separately one by one. As the system image is loaded into a PC, it allows the PC to be immediately bootable and ready for use to run application programs.

Presently in factory, the system image loading procedure is typically carried out after PC products have completed the required assembly and testing procedures, and which includes a first step of manually removing the hard disk modules from the assembled PC units and conveying the removed hard disk modules to a disk copying machine, a second step of visually checking the PC model and selecting a model-compliant system image from a collection of disks, a third step of copying the system image from the selected disk to the hard disk modules with the disk copying machine, and a final step of reinstalling the system image loaded hard disk modules back to the PC units.

One drawback to the above-mentioned practice, however, is that the removal, conveyance, and reinstallation of the hard disk modules during the system image loading procedure would undoubtedly be highly laborious and time-consuming and easy to cause damage to the hard disk modules. Moreover, since it requires the working personnel to visually check the PC model and select a model-compliant system image from several disks, an incorrect system image could be inadvertently selected and loaded into the hard disk modules due to human errors.

### SUMMARY OF THE INVENTION

It is therefore an objective of this invention to provide a computer platform system image automatic loading method and system which is capable of loading a system image into a PC without having to remove the PC's hard disk module.

It is another objective of this invention to provide a computer platform system image automatic loading method and system which is capable of loading a system image into a PC by automatically selecting a model-compliant system image based on the PC's particular model without having to be selected by human so that the PC can be loaded with a correct system image.

The computer platform system image automatic loading method and system according to the invention is designed for use with a server in a computer production line for providing a system image automatic loading procedure that is capable of automatically loading a system image into each computer platform being manufactured on the production line, such as desktop computer, notebook computer, tablet computer, pocket computer, network server, and so on, for the purpose of allowing each manufactured computer platform to be preloaded with operating system and application programs before being shipped to the market or customers.

The computer platform system image automatic loading method and system according to the invention is characterized by the use of network technology to remotely detect the model of each linked PC, and then download a model-compliant system image in a multicast manner to all of the linked PC units. This feature allows the loading of system image into a PC without having to remove the PC's hard disk module and without the need to manually select a model-compliant system image, and therefore allows the PC production process to be more efficient and reliable than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the computer platform system image automatic loading system according to the invention.

### DETAILED DESCRIPTION OF PREFERRED EMBODIMENTS

The computer platform system image automatic loading method and system according to the invention is disclosed in full details by way of preferred embodiments in the following with reference to the accompanying drawings.

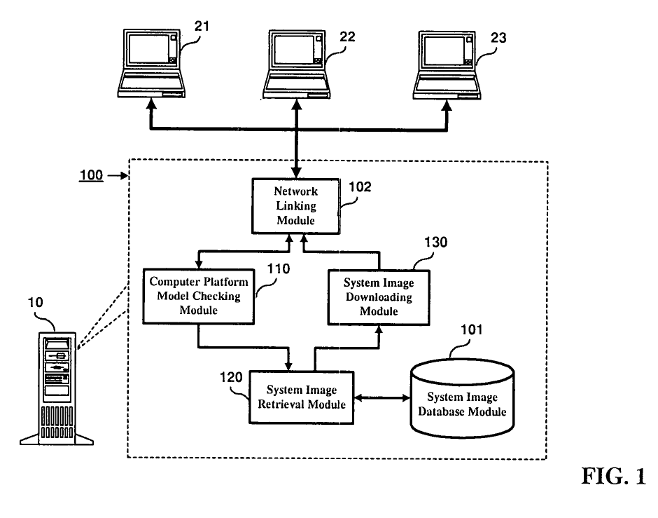

FIG. 1 is a schematic diagram showing the application architecture and modularized object-oriented component model of the computer platform system image automatic loading system according to the invention (as the part enclosed in the dotted box indicated by the reference numeral 100). As shown, the computer platform system image automatic loading system of the invention 100 is designed for use in conjunction with a server 10 (such as a Microsoft Windows 2000 based server) on a computer production line for providing a system image automatic loading procedure for a number of computer platforms 21, 22, 23, such as desktop computers, notebook computers, tablet computers, pocket computers, network servers, and so on, for the purpose of automatically loading a system image into each of the computer platforms 21, 22, 23 on the computer production line (note that in the example of FIG. 1, three computer platforms are illustrated for demonstrative purpose, but in practice, the maximum number of computer platforms that can concurrently undergo the system image loading procedure is up to 180 or more depending on the capability of the operating system of the server 10.

As shown in FIG. 1, the modularized object-oriented component model of the computer platform system image automatic loading system of the invention 100 comprises: (a) a system image database module 101; (b) a network linking module 102; (c) a computer platform model checking module 110; (d) a system image retrieval module 120; and (e) a system image downloading module 130.

The system image database module 101 is used to prestore a variety of system images for various models of computer platforms. For example, notebook computer and tablet computer are two different types of personal computers with different hardware configurations and utilization purposes, and therefore need different operating systems and application programs. For this sake, a first kind of system image for notebook computer and a second kind of system image are prepared and stored into the system image database module 101, which can be retrieved for loading respectively to a notebook computer and a tablet computer.

The network linking module 102 is used to link all the computer platforms 21, 22, 23 concurrently to the server 10, for the purpose of allowing the computer platform system image automatic loading system of the invention 100 to remotely perform a system image automatic loading procedure on all of these computer platforms 21, 22, 23 concurrently via the network linking module 102.

The computer platform model checking module 110 is capable of remotely checking the model of each of the computer platforms 21, 22, 23 to thereby issue a corresponding model indication message to the system image retrieval module 120. In practical implementation, for example, the computer platform model checking module 110 can remotely read out a product serial number embedded in a specific memory address in each of the computer platforms 21, 22, 23 to thereby determine the model of each of the computer platforms 21, 22, 23.

The system image retrieval module 120 is capable of responding to the model indication message from the computer platform model checking module 110 by retrieving a corresponding model-compliant system image from the system image database module 101.

The system image downloading module 130 is capable of downloading the system image retrieved by the system image retrieval module 120 from the system image database module 101 concurrently via the network linking module 102 to all of the computer platforms 21, 22, 23 so as to load the system image into the computer platforms 21, 22, 23. In practical implementation, for example, the system image downloading module 130 utilizes a multicast method to concurrently download the system image via the network linking module 102 to all of the computer platforms 21, 22, 23. Further, as the downloading procedure is completed, the system image downloading module 130 is further capable of performing a CRC (Cyclic Redundancy Checking) procedure to check whether the loaded system image in each of the computer platforms 21, 22, 23 is correctly transmitted, so as to ensure that each of the computer platforms 21, 22, 23 is loaded with the system image correctly.

Referring to FIG. 1, in actual operation, when the computer platforms 21, 22, 23 have completed all the required assembly and testing procedures, they are all linked to the server 10 for the computer platform system image automatic loading system of the invention 100 installed on the server 10 to perform a concurrent system image automatic loading procedure on the computer platforms 21, 22, 23. In the first step, the computer platform model checking module 110 is activated to remotely check the model of each of the computer platforms 21, 22, 23 and thereby issue a corresponding model indication message to the system image retrieval module 120, causing the system image retrieval module 120 to respond by retrieving a corresponding model-compliant system image from the system image database module 101. Subsequently, the system image downloading module 130 is activated to download the system image retrieved by the system image retrieval module 120 from the system image database module 101 concurrently in a multicast manner via the network linking module 102 to all of the computer platforms 21, 22, 23 so as to load the system image into the computer platforms 21, 22, 23. As the downloading procedure is completed, the system image downloading module 130 then perform a CRC procedure to check whether the loaded system image into the computer platforms 21, 22, 23 is correctly transmitted, so as to ensure that each of the computer platforms 21, 22, 23 is loaded with the system image correctly. This completes the system image automatic loading procedure.

In conclusion, the invention provides a computer platform system image automatic loading method and system for use with a server on a computer production line for providing a system image automatic loading procedure for a number of computer platforms on the computer production line, and which is characterized by the use of network technology to remotely detect the model of each linked computer platform, and then download a model-compliant system image in a multicast manner to all of the linked computer platforms. This feature allows the loading of system image into computer platforms without having to remove hard disk modules therefrom and without the need to manually select a model-compliant system image, and therefore allows the computer production process to be more efficient and reliable than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform system image automatic loading method for use on a server for performing a system image automatic loading procedure on a computer platform;
the computer platform system image automatic loading method comprising:
on the server, building a system image database which prestores a variety of system images for various models of computer platforms;
linking the computer platform to the server;
remotely checking the model of the computer platform to thereby issue a corresponding model indication message;
responding to the model indication message by retrieving a corresponding model-compliant system image from the system image database; and
downloading the retrieved system image to the computer platform so as to load the system image into the computer platform.

2. The computer platform system image automatic loading method of claim 1, wherein the computer platform is a desktop computer.

3. The computer platform system image automatic loading method of claim 1, wherein the computer platform is a notebook computer.

4. The computer platform system image automatic loading method of claim 1, wherein the computer platform is a tablet computer.

5. The computer platform system image automatic loading method of claim 1, wherein the computer platform is a pocket computer.

6. The computer platform system image automatic loading method of claim 1, wherein the computer platform is a network server.

7. The computer platform system image automatic loading method of claim 1, wherein the system image is downloaded by in a multicast manner to the computer platform.

8. The computer platform system image automatic loading method of claim 1, further comprising:
performing a CRC (Cyclic Redundancy Checking) procedure after the system image has been downloaded to the computer platform to check whether the loaded system image is correctly transmitted.

9. A computer platform system image automatic loading system for use with a server for performing a system image automatic loading procedure on a computer platform;
the computer platform system image automatic loading system comprising:
a system image database module, which is used to prestore a variety of system images for various models of computer platforms;
a network linking module, which is used to link the computer platform to the server and this computer platform system image automatic loading system;
a computer platform model checking module, which is capable of remotely checking the model of the computer platform via the network linking module to thereby issue a corresponding model indication message;
a system image retrieval module, which is capable of responding to the model indication message from the computer platform model checking module by retrieving a corresponding model-compliant system image from the system image database module; and
a system image downloading module, which is capable of downloading the system image retrieved by the system image retrieval module from the system image database module via the network linking module to the computer platform so as to load the system image into the computer platform.

10. The computer platform system image automatic loading system of claim 9, wherein the computer platform is a desktop computer.

11. The computer platform system image automatic loading system of claim 9, wherein the computer platform is a notebook computer.

12. The computer platform system image automatic loading system of claim 9, wherein the computer platform is a tablet computer.

13. The computer platform system image automatic loading system of claim 9, wherein the computer platform is a pocket computer.

14. The computer platform system image automatic loading system of claim 9, wherein the computer platform is a network server.

15. The computer platform system image automatic loading system of claim 9, wherein the system image downloading module downloads the system image in a multicast manner via the network linking module to the computer platform.

16. The computer platform system image automatic loading system of claim 9, wherein the system image downloading module is further capable of performing a CRC (Cyclic Redundancy Checking) procedure after the system image has been downloaded to the computer platform to check whether the loaded system image is correctly transmitted.
